(19) United States
(12) Patent Application Publication
(10) Pub. No.: US 2009/0149580 A1
(43) Pub. Date: Jun. 11, 2009

(54) NON-YELLOWING FLOCK ADHESIVE

(76) Inventors: PATRICK A. WARREN, Erie, PA (US); Rebecca S. Cowles, WattsBurg, PA (US)

Correspondence Address: LORD CORPORATION;PATENT & LEGAL SERVICES, 111 LORD DRIVE, P.O. Box 8012, CARY, NC, 27512-8012, US

(21) Appl. No.: 12/331,931

(22) Filed: Dec. 10, 2008

Related U.S. Application Data
(60) Provisional application No. 61/012,600, filed on Dec. 10, 2007.

(51) Int. Cl. C08K 5/3435; C08G 18/32; C08K 5/34; C08L 75/00

(52) U.S. Cl. 524/99; 528/66; 524/590; 524/86

(57) ABSTRACT

Disclosed is a flock adhesive composition having a polyurethane coating comprising about 90 to 99 dry weight percent of a polyurethane component consisting essentially of the reaction product of a diisocyanate, a poly(alkylene oxide) polyol, and a di or tri-functional hydroxyl compound; wherein when subjected to a UV exposure of 601 kJ/m2 the resulting color change comprises a delta E of less than 9.0 and a delta b of less than 5.0. The flock adhesive is resistant to natural yellowing and can be employed as a clear flock adhesive or combined with pigment to provide a color stable flock adhesive.

### CROSS REFERENCE TO RELATED APPLICATIONS

The present application claims priority under 35 U.S.C. § 119(e) from U.S. Provisional Patent Application Ser. No. 61/012,600 filed Dec. 10, 2007, entitled “Clear Non-Yellowing Flock Adhesive”, the disclosure of which is incorporated herein by reference.

### FIELD OF THE INVENTION

The invention relates to polyurethane adhesives. More specifically, the invention relates to high-strength and abrasion-resistant flock adhesive compositions which are based on polyurethane prepolymers and various additives which reduce or eliminate yellowing of the urethane polymers.

### BACKGROUND OF THE INVENTION

The preparation of flocked rubber articles wherein flocks are fixed to the surface of the rubber material through an adhesive layer such as a polyurethane are well known. In such processes, the rubber surface is coated with a layer of the adhesive and short staple fibers are applied perpendicularly thereof utilizing an electrical field. The resulting electrostatically flocked articles are characterized by a fabric-like surface of relatively low friction. This feature renders flocked rubber articles particularly suitable for the purpose of reducing friction between the sliding glass window and window channel of automobiles.

It is known to provide flock adhesive compositions based upon isocyanate prepolymers, in combination with dinitrosobenzene and epoxy-novolaks. Typical examples of such solvent-containing flocking adhesives are disclosed in U.S. Pat. No. 4,535,121. These adhesives contain polyurethane prepolymers based on diisocyanates and polyols, aromatic dinitroso compounds as adhesion promoters, polyfunctional reaction products of isocyanates and epoxide compounds, low-boiling solvents such as toluene or xylene, as well as conventional fillers, pigments and/or stabilizers. The reaction products of isocyanates and epoxide compounds are produced in the absence of water using reaction catalysts which bring about a direct reaction between the epoxide groups and the isocyanate groups. Examples of such catalysts are alkali phenolates, acetates, lactates, naphthenates and alcoholates, and also alkali salts of fatty acids such as lithium stearate. These reaction products contain no epoxide groups.

Furthermore, prior adhesive compositions almost always require one or more of a dinitroso compound, an oxime compound, a polyisocyanate compound, and an oxidizing agent. The high toxicity of these ingredients poses serious handling and safety problems, and the dinitroso compounds (e.g. poly-C nitroso), particularly poly(p-dinitrosobenzene poly DNB or p-dinitrosobenzene (DNB), exhibit fuming at relatively high cure temperatures. Additionally, these materials are known to cause yellowing of the adhesive composition requiring addition of carbon black or other pigment to enhance the aesthetic appearance of the finished flocked article.

It would be desirable to provide a flock adhesive which is clear and/or does not exhibit yellowing due to exposure to sunlight. Unfortunately, due to the necessary addition of DNB to provide adhesion and natural yellowing of urethanes in the presence of sunlight, this has heretofore been unavailable.

Therefore it would be desirable to provide a flock adhesive which resists yellowing so as to be used as a clear coating/adhesive.

### SUMMARY OF THE INVENTION

The preparation of flocked articles, wherein flock is affixed to the surface of a thermoplastic or elastomeric material through an adhesive layer such as a polyurethane, is well known. In such processes, the elastomeric surface is coated with a layer of the adhesive and short staple fibers are applied perpendicularly thereto, often utilizing an electrical field. The resulting electrostatically flocked articles are characterized by a fabric like surface of relatively low friction. This feature renders flocked articles particularly suitable for the purpose of reducing friction between the sliding glass window and window channel of automobiles, or for enhancing the appearance, utility, and appeal of various pockets and glove boxes found in automotive interiors. In view of the abrasion and stress involved in these applications, it is imperative that the adhesive used to bond the flock to the thermoplastic or elastomeric material contain components which not only bond to the flock, but also bond to the thermoplastic or elastomeric substrate.

In one aspect of the present invention, a flock adhesive composition is provided comprising a polyurethane coating comprising about 90 to 99 dry weight percent of a polyurethane component consisting essentially of the reaction product of a diisocyanate, a poly(alkylene oxide) polyol, and a di or tri-functional hydroxyl compound; wherein when subjected to a UV exposure of 601 kJ/m2 the resulting color change comprises a delta E of less than 9.0 and a delta b of less than 5.0. In a preferred embodiment of the present invention, the flock adhesive is substantially free of nitroso compounds.

In another embodiment of the present invention, the adhesive further comprises a UV absorber, preferably a hydroxyphenylbenzotriazole UV absorber. In still another embodiment of the present invention, the composition further comprises a UV stabilizer, preferably a mixture of bis(1,2,2,6,6-pentamethyl-4-piperidinyl)sebacate and methyl 1,2,2,6,6-pentamethyl-4-piperidinyl sebacate. In yet another embodiment of the present invention, the adhesive further comprises an antioxidant, preferably a sterically-hindered, phenolic anti-oxidant. In another embodiment of the present invention, the adhesive further comprises a catalyst.

In one embodiment of the present invention, the at least one poly(alkylene oxide) polyol is a mixture of a first poly(alkylene oxide) polyol having a molecular weight in the range of from about 600 to 1,400 and a second poly(alkylene oxide) polyol having a molecular weight in the range of from about 1,600 to 2,400. In another embodiment of the present invention, the first poly(alkylene oxide) polyol and the second poly(alkylene oxide) polyol are both a poly(propylene oxide) diol.

In a further embodiment of the present invention, the di or tri-functional hydroxy compound is selected from the group consisting of trimethylolpropane, 1,2,6-hexane triol, glycerol, 1,4-butane diol, 1,3-butylene glycol, 1,6-hexane diol, and cyclohexane diol. In another embodiment of the present invention, the hydroxy compound is selected from the group consisting of trimethylolpropane, 1,2,6-hexanetriol, and glycerol.

In still another embodiment of the present invention, the isocyanate compound is selected from the group consisting of 4,4′-diphenylmethane diisocyanate, 4,4′-biphenyl diisocyanate, cyclolhexylene-1,4-diisocyanate, and 1,6-hexamethylene diisocyanate, preferably 4,4′-diphenylmethane diisocyanate. In another embodiment of the present invention the poly(alkylene oxide) polyol comprises polypropylene glycol.

In another aspect of the present invention, a flock adhesive is provided consisting essentially of a UV absorber, UV stabilizer, an Anti-oxidant, a curative, and a polyurethane component consisting essentially of the reaction product of a diisocyanate, a poly(alkylene oxide) polyol, and a di or tri-functional hydroxyl compound; wherein when subjected to a UV exposure of 601 kJ/nm2 the resulting color change comprises a delta E of less than 9.0 and a delta b of less than 5.0.

### DETAILED DESCRIPTION OF THE PREFERRED EMBODIMENTS

In a first embodiment of the present invention, a flock adhesive is provided comprising a polyurethane prepolymer which when applied to an EPDM substrate and subjected to UV radiation, shows a minimal color change and yellowing. Color change and yellowing are determined by commonly known weatherometer testing methods such as exposing the samples to 601 kJ/m2 of UV light and calculating delta b (yellowing) and delta E (color change) as is known in the art. The adhesives of the present invention exhibit a delta b of less than 5.0 and a delta E of less than 9.0.

The adhesive compositions of the present invention, comprise either no nitroso compound, such as dinitrosobenzene (DNB) or are essentially absent a nitroso compound such as dinitrosobenzene (DNB). It has been discovered that nitroso compounds will cause a polyurethane formulation to yellow or otherwise discolor. “Essentially absent” in this context is defined as present in less than the amount which would cause the adhesive composition to yellow, generally less than 1.0 percent and more preferably less than 0.5 weight percent.

Additionally in a further preferred embodiment of the present invention, the flock adhesive is substantially absent an epoxy composition, or more preferably absent an epoxy composition. Thus, in a most preferred embodiment of the present invention, the flock adhesives consist essentially of a polyurethane prepolymer and a minority of additives.

In one aspect of the present invention, the preferred polyurethane prepolymer is prepared by reacting at least one poly(alkylene oxide) polyol, a hydroxy compound, and an isocyanate compound in the presence of one or more appropriate solvents.

The at least one poly(alkylene oxide) polyol used to prepare the preferred polyurethane prepolymer can be essentially any poly(alkylene oxide) polyol known in the art having at least two hydroxyl groups. The polyols are normally obtained from the polymerization, including block copolymerization, of cyclic ethers such as alkylene oxides, dioxolane and tetrahydrofuran, the condensation of glycols, or the condensation of cyclic ethers with glycols. They are well-known articles of commerce, and are also called polyalkylene ether glycols, polyalkylene glycols, polyalkylene oxide glycols, polyglycols and polyoxyalkylene glycols. They may be represented by the formula HO(RO)ₙ H, in which R is an alkylene radical and n is at least 2. The alkylene radical can be a single chain or can consist of two or more alkylene chains separated from each other by an ether oxygen atom. Preferred poly(alkylene oxide) polyols have from 1 to 9, preferably 1 to 6, carbon atoms in the alkylene chain separating each pair of oxygen atoms and have a number average molecular weight in the range of from about 100 to about 4,000, preferably about 100 to about 2,500. Not all the alkylene units need be the same. Poly(alkylene oxide) polyols formed by the copolymerization or condensation of mixtures of different cyclic ethers, glycols, or glycols and cyclic ethers can be used; as can poly(alkylene oxide) polyols derived from cyclic ethers such as dioxolane, which affords a polyol having the formula HO(C—H₂ OCH₂ CH₂O)ₙ H, where n is greater than 1. The alkylene unit can be a straight or a branched chain, as in poly(propylene oxide) polyol. In the case where the alkylene unit is ethylene, it can be advantageous to incorporate the unit into a copolymer, for example, as a copolymer of ethylene oxide and propylene oxide, with up to 80 percent of such copolymer comprising ethylene oxide.

Representative poly(alkylene oxide) polyols for use in the present invention include poly(ethylene oxide) polyols, poly(propylene oxide) polyols, poly(tetramethylene oxide) polyols, poly(nonamethylene oxide) polyols, poly(oxymethylene-ethylene oxide) polyols, poly(ethylene oxide-propylene oxide copolymer) polyols, and poly(pentaerythritol-ethylene oxide) polyols. Thus, the poly(alkylene oxide) polyols will generally have from 2 to 6 hydroxyl groups, with such polyols having 2 hydroxyl groups being currently preferred. Preferred poly(alkylene oxide) polyols are poly(propylene oxide) polyols, poly(tetra-methylene oxide) polyols, poly(ethylene oxide-propylene oxide) polyols, and poly(ethylene oxide) polyols, with poly(propylene oxide) polyols, especially poly(propylene oxide) diol, being preferred.

It is particularly preferred to utilize more than one poly(alkylene oxide) polyol in the present invention such as a combination of polyols which differ in molecular weight. Specifically, the combination of a poly(alkylene oxide) polyol having a molecular weight in the range of from about 600 to 1,400, preferably about 800 to 1,200, with a second poly(alkylene oxide) polyol having a molecular weight in the range of from about 1,600 to 2,400, preferably about 1,800 to 2,200, has been shown to be particularly useful in the present invention. When using a combination of polyols having different molecular weights, it is preferred to use poly(propylene oxide) polyols, especially poly(propylene oxide) diols, having different molecular weights. The first poly(alkylene oxide) polyol of such a molecular weight combination is typically utilized in an amount from about 5 to about 20, preferably from about 10 to about 14, percent by weight of the total polyols utilized to prepare the first polyurethane prepolymer (hereinafter “total polyols”). The second poly(alkylene oxide) polyol of such a molecular weight combination is typically utilized in an amount from about 60 to about 90, preferably from about 70 to about 85, percent by weight of the total polyols. If only one poly(alkylene oxide) polyol is utilized in lieu of a combination of such polyols, the single poly(alkylene oxide) polyol is employed in an amount ranging from about 5 to 95, preferably from about 80 to 90, percent by weight of the total polyols.

The preparation of the preferred polyurethane prepolymer of the invention also involves the use of a di or tri-functional hydroxy compound, preferably a tri-functional hydroxy compound so as to provide a branched or T-shaped structure to at least some segments of the polyurethane prepolymer. If desired, substantially any of the known monomeric alcohols having at least two hydroxyl groups, and polymeric non-poly(alkylene oxide) polyols having at least two hydroxyl groups, can be employed as the hydroxy compound in combination with the poly(alkylene oxide) polyols to form the first polyurethane prepolymer of the invention.

Representative monomeric and polymeric polyols and polyesters which can be utilized as the present di or tri hydroxy compound include trimethylolpropane; 1,2,6-hexane triol; glycerol; 1,4-butane diol; 1,3-butylene glycol; 1,6-hexane diol; cyclohexane diol; 4,4;-methylenebis(cyclohexanol); erythritol; pentaerythritol; neopentyl glycol; polycaprolactone diols and triols, poly(butadiene) diols; hydroxylated poly(butadiene) dienes; poly(tetramethylene adipate) diol; poly(ethylene succinate) diol; poly(1,3-butylene sebacate) diol; and (1,3-butylene glycol/glycerine/adipic acid/isophthalic acid) diol and triols. Mixtures of such monomeric and polymeric compounds can also be employed. Trifunctional hydroxy compounds such as trimethylolpropane, 1,2,6-hexane triol and glycerol are presently preferred. The hydroxy compound (also considered a polyol for purposes of the total polyols utilized to prepare the first polyurethane prepolymer) is utilized in an amount from about 4 to about 10, preferably from about 6 to about 8 percent by weight of the total polyols.

The single poly(alkylene oxide) polyol or combination of poly(alkylene oxide) polyols and the hydroxy compound (i.e., the total polyols) are typically utilized in an amount ranging from about 40 to 80, preferably from about 50 to 65, percent by weight of the total dry (excluding solvent) solid weight of the prepolymer composition.

The isocyanate compound utilized in the preparation of the first polyurethane prepolymer of the present invention can essentially be any polyisocyanate having at least two reactive isocyanate groups. Typical isocyanate compounds include, without limitation, polyisocyanates such as 4,4′-diphenylmethane diisocyanate; 4,4′-biphenyl diisocyanate; cyclohexylene-1,4-diisocyanate; 1,6-hexamethylene diisocyanate; 1,8-octamethylene diisocyanate; 1,12-dodecamethylene diisocyanate; 2,2,4-trimethylhexamethylene diisocyanate; and the like; 3,3′diisocyanatodipropyl ether; 3-isocyanatomethyl-3,5,5′-trimethylcyclohexyl isocyanate; cyclopentalene-1,3-diisocyanate; methyl 2,6-diisocycanatocaprolate; bis-(2-isocyanatoethyl)fumarate; 4-methyl-1,3-diisocyanatocyclohexane; transvinylene diisocyanate and similar unsaturated polyisocyanates; 4,4′-methylene-bis-(cyclohexylisocyanate) and related polyisocyanates; methane diisocyanates; bis-(2-isocyanatoethyl)carbonate and similar carbonate polyisocyanates; N,N′N″-tris-(6-isocyanatolhexanethylene)biuret and related polyisocyanates; as well as other known polyisocyanates derived from-n aliphatic polyamines; aromatic polyisocyanates such as toluene diisocyanates; xylene diisocyanates; dianisidine diisocyanate; 1-ethoxy-2,4-diisocyanato-benzene; 1-chloro-2,4-diisocyanatobenzene; tris(4-isocyanatophenyl) methane; naphthalene diisocyanates; phenylene diisocyanates; 3,3′-dimethyl-4,4′-biphenyl diisocyanate; p-isocyanatobenzoyl isocyanates; tetrachloro-1,3-phenylene diisocyanate; and the like. At the present time, 4,4′-diphenylmethane diisocyanate is the preferred isocyanate compound for use in the present invention. The isocyanate compound is typically utilized in an amount ranging from about 20 to 60, preferably from about 35 to 45, percent by weight of the total dry solid weight of the prepolymer composition.

The preferred polyurethane prepolymer of the invention is typically prepared by combining the poly(alkylene oxide) polyols and the hydroxy compound together in the presence of a solvent at a temperature between about 100° C. and 200° C. The mixture is then typically cooled to between about 50° C. and 70° C. after which the isocyanate compound and any additional solvent are added. The resulting mixture is heated to between about 80° C. and 110° C. for about 3 to 6 hours to form a high viscosity prepolymer. When selecting the amounts of isocyanate and polyhydroxy compounds to be used, it is preferable to create in the mixture a NCO:OH functionality ratio of between about 1.05:1 and 10.00:1, preferably between about 1.50:1 and 4.00:1. The reaction is preferably carried out in an inert atmosphere (e.g., nitrogen) in the presence of a dry, non-reactive organic solvent. Typical solvents include xylene, toluene, methylisobutyl-ketone, acetate ethers and mixtures of acetate ethers such as the mixture of 85% propylene glycol methyl ether acetate and 15% dipropylene glycol methyl ether acetate supplied by the Dow Chemical Company under the tradename DOWANOL® BC-300, and combinations of such solvents. The solvent or solvent combination is utilized in an amount sufficient to produce an overall solids content of the polyurethane prepolymer of between about 25 and 90 percent, preferably between about 45 and 75 percent. The particular solvent, or combination of solvents, is selected depending on the particular isocyanate and polyol compounds utilized to produce the polyurethane prepolymer. Such selection of solvents to appropriately dissolve polyurethane prepolymers is well known in the art.

In a preferred embodiment of the present invention, the non-yellowing attributes of the pre-polymer are enhanced with the addition of small amounts of a UV absorber, anti-oxidant, and/or a UV stabilizer. The UV absorber preferably comprises one of the hydroxyphenylbenzotriazole class, specifically developed for coatings. Due to its broad UV absorption, Tinuvin® 328 (available from Ciba®) is particularly preferred. The anti-oxidant preferably comprises a sterically-hindered, phenolic anti-oxidant that is particularly suitable for organic substrates. Examples of suitable antioxidants include Irganox® 1135, Irganox 1010 and Irganox 245 (available from Ciba®). The UV stabilizer preferably comprises a general-purpose liquid hindered-amine light stabilizer (HALS) HALS derivatives, and benzoates and benzoate derivatives. Preferred UV stabilizers that may be used to practice this invention include: a mixture of bis(1,2,2,6,6-pentamethyl-4-piperidinyl)sebacate and methyl 1,2,2,6,6-pentamethyl-4-piperidinyl sebacate (available from Ciba® as Tinuvin® 292 SD).

### EXAMPLES

The compositions of the present invention are based on urethane prepolymers. Formulation A provides only the preferred prepolymer with an appropriate catalyst. Formulation B provides the preferred prepolymer and catalyst along with additional additives to further reduce yellowing and discoloration.

Preferred Prepolymer (PP1)

| Compound | Wet Weight Percent |
|---|---|
| Polypropylene Glycol | 3.22 |
| Trimethylol propane | 4.84 |
| 4,4′-diphenylmethane diisocyanate | 16.13 |
| Solvents | 75.81 |
| Total | 100.00 |

Testing. Brush apply flock adhesives onto clean glass plaques, bake parts for 1.5 minutes at 290° F., 350° F., and 400° F. Remove parts from cure oven and perform tack test on adhesive films. Use same cured plaques that were tested for tack, to observe for yellowing of samples after post bake.
Glass Used. Single strength glass plaques, cleaned with vinegar based window cleaner
Adhesive application: Adhesive was brush applied at a wet film thickness (WFT) of 4-6 mils.

FORMULATION A

| Raw Material | % Solids | Dry Weight | % Dry Basis |
|---|---|---|---|
| PP1 | 55.00% | 53.784 | 99.60% |
| Hydroxyphenylbenzotriazole UV | 100.00% | 0.000 | 0.00% |
| Absorber | | | |
| UV Stabilizer | 100.00% | 0.000 | 0.00% |
| sterically-hindered, phenolic | 100.00% | 0.000 | 0.00% |
| Anti-oxidant | | | |
| Urethane Catalyst | 15.00% | 0.225 | 0.416% |
| | 0.00% | 0.000 | |
| Total | | 54.0 | 100.0% |
| Solids | 54.00% | 54.0 | |

*Mixture of bis(1,2,2,6,6-pentamethyl-4-piperidinyl)sebacate and methyl 1,2,2,6,6-pentamethyl-4-piperidinyl sebacate

FORMULATION B

| Raw Material | % Solids | Dry Weight | % Dry Basis |
|---|---|---|---|
| R097 | 55.00% | 53.033 | 95.10% |
| Hydroxyphenylbenzotriazole UV | 100.00% | 1.000 | 1.79% |
| Absorber | | | |
| UV Stabilizer* | 100.00% | 1.000 | 1.79% |
| sterically-hindered, phenolic | 100.00% | 0.500 | 0.90% |
| Anti-oxidant | | | |
| Urethane Catalyst | 15.00% | 0.225 | 0.42% |
| | 0.00% | 0.000 | |
| Total | | 55.8 | 100.0% |
| Solids | 55.77% | 55.8 | |

*Mixture of bis(1,2,2,6,6-pentamethyl-4-piperidinyl)sebacate and methyl 1,2,2,6,6-pentamethyl-4-piperidinyl sebacate

Results: Tack Test Results

| Adhesive | Formulation A | Formulation B |
|---|---|---|
| | Cure of 1.5 minutes @ 290° F. | |
| Tack | 3 | 5 |
| Rating | | |
| | Cure of 1.5 minutes @ 350° F. | |
| Tack | 5 | 5 |
| Rating | | |
| | Cure of 1.5 minutes @ 400° F. | |
| Tack | 5 | 5 |
| Rating | | |

Q-Tip Tack Test Rating Scale*
1 Very poor, very tacky, uncured
2 Poor, tacky
3 Fail, slight tack
4 Good, very little tack
5 Excellent, no tack
*Tack rating on removal from cure oven

Initial yellowing was tested by curing the samples immediately after adhesive application then exposing the samples to a temperature of 150° F. for two hours. A rating of “Pass” indicates negligible or unnoticeable appearance of yellowing in the sample.

Initial Yellowing Results

| Adhesive | Formulation A | Formulation B |
|---|---|---|
| | Cure of 1.5 minutes @ 290° F. | |
| Yellow | Pass | Pass |
| Rating | | |
| | Cure of 1.5 minutes @ 350° F. | |
| Yellow | Pass | Pass |
| Rating | | |
| | Cure of 1.5 minutes @ 400° F. | |
| Yellow | Pass | Pass |
| Rating | | |

In addition to the initial yellowing test based on heating of the samples a traditional weatherometer test was performed to simulate longer term V exposure. In testing for the level of non-yellowing, samples were evaluated on black sponge EPDM profile and subjected to 601 KJ/m2 of UV light through standard weatherometer color change testing as is known in the art. It was found that the prototype adhesive provided lower delta b and delta E values than a commercially available prior art flock adhesive

Prior Art Coating Without UV Exposure

| Observation | L* | a* | b* | C* | h |
|---|---|---|---|---|---|
| D65 10 Deg | 55.49 | −1.13 | 4.51 | 4.65 | 104.07 |
| A10 Deg | 55.70 | 0.44 | 4.45 | 4.47 | 84.35 |
| F02 10 Deg | 55.52 | −1.10 | 4.67 | 4.80 | 103.21 |

Prior Art Coating With UV Exposure

| Observation | L* | a* | b* | C* | h |
|---|---|---|---|---|---|
| D65 10 Deg | 60.49 | 1.51 | 11.84 | 11.93 | 82.75 |
| A10 Deg | 61.43 | 4.22 | 12.54 | 13.23 | 71.40 |
| F02 10 Deg | 61.10 | 0.83 | 13.51 | 13.54 | 86.48 |

Weatherometer Results - Prior Art

| Observation | DL* | Da* | Db* | DC* | DH* | DE* |
|---|---|---|---|---|---|---|
| D65 10 Deg | 5.00 | 2.64 | 7.32 | 7.28 | −2.76 | 9.25 |
| A10 Deg | 5.73 | 3.78 | 8.09 | 8.76 | −1.74 | 10.62 |
| F02 10 Deg | 5.58 | 1.93 | 8.84 | 8.74 | −2.35 | 10.63 |

Prototype Coating Without UV Exposure

| Observation | L* | a* | b* | C* | h |
|---|---|---|---|---|---|
| D65 10 Deg | 54.12 | −1.08 | 8.81 | 8.88 | 96.99 |
| A10 Deg | 54.61 | 1.33 | 9.00 | 9.10 | 81.62 |
| F02 10 Deg | 54.37 | −1.25 | 9.67 | 9.75 | 97.38 |

Prototype Coating With UV Exposure

| Observation | L* | a* | b* | C* | h |
|---|---|---|---|---|---|
| D65 10 Deg | 60.44 | 1.43 | 11.53 | 11.62 | 82.94 |
| A10 Deg | 61.36 | 4.19 | 12.19 | 12.89 | 71.05 |
| F02 10 Deg | 61.01 | 0.75 | 13.14 | 13.16 | 86.74 |

Weatherometer Results - Prototype

| Observation | DL* | Da* | Db* | DC* | DH* | DE* |
|---|---|---|---|---|---|---|
| D65 10 Deg | 6.32 | 2.51 | 2.72 | 2.74 | −2.48 | 7.32 |
| A10 Deg | 6.75 | 2.86 | 3.19 | 3.79 | −2.00 | 7.99 |
| F02 10 Deg | 6.64 | 2.00 | 3.47 | 3.41 | −2.10 | 7.75 |

Delta b and delta E indicate the difference in color between samples measured before and after the weatherometer testing. Lower delta E and delta b means less color and less yellow index change respectively indicating better performance of the adhesive. As demonstrated in the above-examples, the prior art adhesive exhibited higher delta b and delta E than the adhesive of the present invention.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

What is claimed is:

1. A flock adhesive composition comprising a polyurethane coating comprising about 90 to 99 dry weight percent of a polyurethane component consisting essentially of the reaction product of a diisocyanate, a poly(alkylene oxide) polyol, and a di or tri-functional hydroxyl compound; wherein when subjected to a UV exposure of 601 kJ/m2 the resulting color change comprises a delta E of less than 9.0 and a delta b of less than 5.0.

2. The adhesive of claim 1, wherein said adhesive is substantially free of nitroso compounds.

3. The adhesive of claim 1 further comprising a UV absorber.

4. The adhesive of claim 3, wherein the UV absorber comprises hydroxyphenylbenzotriazole.

5. The adhesive of claim 1, further comprising a UV stabilizer.

6. The flock adhesive of claim 5, wherein the UV stabilizer comprises a mixture of bis(1,2,2,6,6-pentamethyl-4-piperidinyl)sebacate and methyl 1,2,2,6,6-pentamethyl-4-piperidinyl sebacate.

7. The adhesive of claim 1, further comprising an antioxidant.

8. The adhesive of claim 7, wherein the antioxidant comprises a sterically-hindered, phenolic anti-oxidant.

9. The adhesive of claim 1, further comprising a catalyst.

10. The adhesive of claim 1, wherein the at least one poly(alkylene oxide) polyol is a mixture of a first poly(alkylene oxide) polyol having a molecular weight in the range of from about 600 to 1,400 and a second poly(alkylene oxide) polyol having a molecular weight in the range of from about 1,600 to 2,400.

11. The adhesive of claim 10, wherein the first poly(alkylene oxide) polyol and the second poly(alkylene oxide) polyol are both a poly(propylene oxide) diol.

12. The adhesive of claim 1, wherein the di or tri-functional hydroxy compound is selected from the group consisting of trimethylolpropane, 1,2,6-hexane triol, glycerol, 1,4-butane diol, 1,3-butylene glycol, 1,6-hexane diol, and cyclohexane diol.

13. The adhesive of claim 12, wherein the hydroxy compound is selected from the group consisting of trimethylolpropane, 1,2,6-hexane triol, and glycerol.

14. The adhesive of claim 1, wherein the isocyanate compound is selected from the group consisting of 4,4′-diphenylmethane diisocyanate, 4,4′-biphenyl diisocyanate, cyclohexylene- 1,4-diisocyanate, and 1,6-hexamethylene diisocyanate.

15. The adhesive of claim 14, wherein the isocyanate compound is 4,4′-diphenylmethane diisocyanate.

16. The adhesive of claim 1, wherein the poly(alkylene oxide) polyol comprises polypropylene glycol.

17. A flock adhesive composition consisting essentially of a UV absorber, UV stabilizer, an Anti-oxidant, a curative, and a polyurethane component consisting essentially of the reaction product of a diisocyanate, a poly(alkylene oxide) polyol, and a di or tri-functional hydroxyl compound; wherein when subjected to a UV exposure of 601 kJ/m2 the resulting color change comprises a delta E of less than 9.0 and a delta b of less than 5.0.
